(19) United States
(12) Patent Application Publication
(10) Pub. No.: US 2020/0407597 A1
(43) Pub. Date: Dec. 31, 2020

(54) PRE-TREATMENT COMPOSITION

(71) Applicant: HP Indigo B.V., Amstelveen (NL)

(72) Inventors: Inna Tzomik, Ness Ziona (IL); Dima Libster, Ness Ziona (IL); Alexander Stolov, Ness Ziona (IL); Dafna Or-Chen, Ness Ziona (IL); Faina Kogan, Ness Ziona (IL)

(21) Appl. No.: 16/607,746

(22) PCT Filed: Sep. 20, 2017
(86) PCT No.: PCT/EP2017/073826

§ 371 Date: Oct. 24, 2019

(51) Int. Cl. C09J 5/02; C09D 11/54; C09D 11/102; C09D 11/033; C09J 179/02; G03G 15/08

(52) U.S. Cl. CPC C09J 5/02; C09D 11/54; C09D 11/102; C09J 2467/008; C09J 179/02; G03G 15/0822; C09J 2479/02; C09D 11/033

(57) ABSTRACT

The present disclosure relates to a pre-treatment composition for sealing polymeric film, said composition comprising: 0.5 to 10 weight % of a halogenated carboxylic acid, a surfactant, and a liquid solvent.

### BACKGROUND

Polymer films are often used in the packaging industry. As well as being used to manufacture product packaging, polymer films may also be used to produce labels for application to product packaging. For instance, opposing edges of a sheet of polymer film may be sealed together to form a seam. The resulting sleeve may be heat shrunk to the contours of a container to provide a “shrink sleeve” for the container.

In many instances, it may be desirable to print, for example, designs, text or on the polymer films. Such printed films may be used to provide information on the contents of the packaging. For example, shrink sleeves bearing product logos, trademarks, slogans, designs and product information may be heat shrunk to containers as labels. Various printing techniques may be used to print on such polymer films, including, for example, electrophotographic printing.

### DETAILED DESCRIPTION

Before the present disclosure is disclosed and described, it is to be understood that this disclosure is not limited to the particular method steps and materials disclosed herein because such method steps and materials may vary. It is also to be understood that the terminology used herein is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “liquid electrostatic composition” or “liquid electrophotographic composition” generally refers to a composition that is suitable for use in an electrostatic printing process, sometimes termed an electrophotographic printing process.

As used herein, “co-polymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

Unless the context dictates otherwise, the terms “acrylic” and “acrylate” refer to any acrylic or acrylate compound. For example, the term “acrylic” includes acrylic and methacrylic compounds unless the context dictates otherwise. Similarly, the term “acrylate” includes acrylate and methacrylate compounds unless the context dictates otherwise.

As used herein, “electrostatic printing” or “electrophotographic printing” refers to the process that provides an image that is transferred from a photo imaging substrate either directly, or indirectly via an intermediate transfer member, to a print substrate. As such, the image is not substantially absorbed into the photo imaging substrate on which it is applied. Additionally, “electrophotographic printers” or “electrostatic printers” refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g. an electric field having a field gradient of 50-400V/μm, or more, in some examples 600-900V/μm, or more, in some examples 1000 V/cm or more, or in some examples 1500 V/cm or more.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of moulding. In the present disclosure, “melt flow rate” is measured per ASTM D1238-04c Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the electrostatic composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @140° C., units are mPa-s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

If a standard test is mentioned herein, unless otherwise stated, the version of the test to be referred to is the most recent at the time of filing this patent application.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented in this disclosure in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used in this disclosure, weight % (wt %) values are to betaken as referring to a weight-for-weight (w/w) percentage of solids in the composition, and not including the weight of any carrier liquid present.

Unless otherwise stated, any feature described herein can be combined with any aspect or any other feature described herein.

In an aspect, there is provided a pre-treatment composition for sealing polymeric film, said composition comprising: 0.5 to 10 weight % of a halogenated carboxylic acid, a surfactant, and a liquid solvent.

In another aspect, there is provided a method of sealing a first region of polymer film to a second region of polymer film. The method comprises applying a pre-treatment composition comprising 0.5 to 10 weight % of a halogenated carboxylic acid, a surfactant, and a liquid solvent to a first region of polymer film; and sealing the pre-treated first region to a second region of polymer film.

A number of techniques can be used to seal polymer films. For example, depending on the nature of the polymer film, polymer films may be sealed by application of heat and/or pressure, or by solvent-bonding. For example, when sealing under heat and pressure, the heat applied to the polymer film may cause it to soften (e.g. by partial melting). The pressure applied and subsequent cooling allows opposing polymer film surfaces to adhere to one another. With solvent-bonding, on the other hand, a sealing solvent may be applied to selected areas of the polymer film to soften (e.g. by partially dissolving) the polymer in the selected areas. The softened polymer can act as an adhesive so that when an untreated area of polymer film is pressed against the soften polymer, a seal can be formed. In the case of a sheet of polymer film, sealing solvent may be applied, for example, along an edge region of the sheet to soften the polymer at that region. When an opposing edge region of the sheet is pressed against the softened polymer, a seam can be formed, producing a sleeve from the sheet of polymer film. This sleeve may be heat shrunk to conform to the shape of a container, for example, as a heat shrink label.

When electrophotographically printing images onto polymer films, primers can be used to improve adhesion of the printed ink on the polymer film substrate. A suitable primer may be a primer containing polyethylene imine. The present inventors, however, have found that it can be difficult to seal such primed polymer films. Without wishing to be bound by any theory, this is believed to be because the primer can interfere with the sealing process, reducing the efficacy of seal (e.g. seam) formation.

In the present disclosure, the present inventors have developed a pre-treatment composition that can be applied to selected areas of a primed polymer film. The pre-treatment composition may interact (e.g. chemically react) with the primer, reducing the risk of the primer interfering with the sealing process. A seal (e.g. seam) may then be formed between primer-inactivated areas or between primer-inactivated and primer-free areas of the film.

### Halogenated Carboxylic Acid of Pre-Treatment Composition

In the present disclosure, a halogenated carboxylic acid is employed in the pre-treatment composition. Without wishing to be bound by any theory, the halogenated carboxylic acid is believed to interact, for example, chemically react with the primer, rendering it inactive in subsequent sealing steps. Thus, the primer may be effectively “removed” from the pre-treated polymer film surface. In one example, the primer may comprise a polymer (e.g. polyethylene imine) comprising amine pendant groups. The halogenated carboxylic acid may react with the amine groups, converting them into salt form. This may inactivate the polymer, rendering it inactive in subsequent sealing steps. Furthermore, the halogenated carboxylic acid may disrupt any hydrogen bonding network between water molecules and the primer, facilitating salt formation. Thus, the halogenated carboxylic acid may reduce or eliminate the risk of the primer interfering with seal formation, thereby improving the strength of the seal that can be formed.

Any suitable halogenated carboxylic acid may be employed. In one example, the halogenated carboxylic acid may be a halogenated C₁-C₆ carboxylic acid. In some examples, the halogenated carboxylic acid may be a halogenated C₁-C₄ carboxylic acid, for instance, a halogenated C₁-C₃ carboxylic acid. In one example, the halogenated carboxylic acid may be a halogenated acetic acid.

The halogenated carboxylic acid may be a mono-, di- or tri-halo carboxylic acid. In some examples, the carboxylic acid may be a di- or tri-halo carboxylic acid.

In the halogenated carboxylic acid, the carbon atom α- or adjacent to the carboxylic acid functional group may halogenated. In one example, the halogenated carboxylic acid may have the formula:

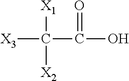

where X₁ and X₂ are each independently selected from F, Cl, Br and I; and
where X₃ is selected from F, Cl, Br, I, H and an alkyl group, for instance, a C₁ to C₅ or C₁ to C₃ alkyl group.

In some examples, X₁ and X₂ are the same. In some examples, X₁, X₂ and X₃ are the same. In other examples, X₁ and X₂ are the same and X₃ is H or an alkyl group, for example, a C₁ to C₅ or C₁ to C₃ alkyl group. In some examples, X₁ and X₂ are each F or Cl and X₃ is H.

In some examples, the halogenated carboxylic acid may be a mono-, di- or tri-halo acetic acid. The halogenated carboxylic acid may be halogenated with a fluoro, chloro, bromo or iodo group, for example, a fluoro or chloro group.

Examples of suitable halogenated carboxylic acids include trichloroacetic acid, dichloroacetic acid, chloroacetic acid, trifluoroacetic acid and difluoroacetic acid.

The halogenated carboxylic acid may be present in an amount of 0.5 to 10 weight % based on the total weight of the pre-treatment composition. In one example, the pre-treatment composition comprises 0.5 to 9 weight % halogenated carboxylic acid. In one example, the pre-treatment composition comprises 0.5 to 8 weight %, for instance, 0.7 to 7 weight % or 1 to 6 weight % halogenated carboxylic acid. In some examples, the halogenated carboxylic acid may be present in an amount of 1 to 5 weight %. In one example, the halogenated carboxylic acid may be present in an amount of 1 to 3 weight % or 2 to 6 weight %. For forming a seam for a heat shrink sleeve, the halogenated carboxylic acid may be present in an amount of 1 to 2 weight %. For forming other types of seal, the halogenated carboxylic acid may be present in an amount of 2 to 5 weight %.

### Surfactant of Pre-Treatment Composition

The pre-treatment composition also comprises a surfactant. The surfactant can facilitate wetting of the primer, enabling reaction between the halogenated carboxylic acid and the primer. In some examples, the surfactant comprises a non-ionic and/or anionic surfactant. The surfactant may have a hydrophilic-lipophilic balance (HLB) of greater than 9, for example, 9 to 13, or 10 to 12. In some examples, the HLB may be determined by using Griffin's method (HLB=20*Mₕ/M, where Mₕ is the molecular mass of the hydrophilic portion of the molecule and M is the molecular mass of the whole molecule).

Examples of suitable anionic surfactants include dodecyl benzene sulfonates, and dodecyl sulfonates. Specific examples include ammonium lauryl sulfates, sodium mireth sulfate, docusate (dodecyl sodium sulfosuccinate), perfluoro octanesulfonates, alkyl ether phosphates. Other examples include carboxylates e.g. sodium stearate, carboxylate-based fluorosulfanates.

In one example, the anionic surfactant comprises sodium dodecyl sulphonate and/or sodium cholate.

Suitable non-ionic surfactants include trisiloxane surfactants. In one example, the trisiloxane surfactant has the formula I below:

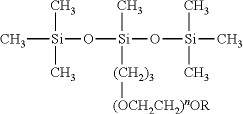

where n is an integer, for example, an integer of at least 1, for example, from 1 to 12; and R is alkyl, for example C₁-C₆ alkyl, or C₁ to C₄ alkyl (e.g. methyl, ethyl, propyl or butyl).

The surfactant may be present in the pre-treatment composition in any suitable amount. For example, the surfactant may be present in an amount of 0.01 to 3 weight % of the total weight of the pre-treatment composition, for instance, 0.01 to 1 weight %. In some examples, the surfactant may be present in an amount of 0.01 to 0.8 weight %, for instance, 0.01 to 0.6 weight % or 0.01 to 0.5 weight %. In one example, the surfactant may be present in an amount of 0.02 to 0.4 weight %, for instance, 0.02 to 0.2 weight % or 0.02 to 0.1 weight % of the total weight of the pre-treatment composition.

### Solvent of Pre-Treatment Composition

Any suitable liquid solvent may be used in the pre-treatment composition. The solvent may be a polar solvent. In some examples, the solvent comprises at least one of water, an alcohol, a ketone and ether solvent.

Examples of suitable alcohols include C₁ to C₆ alcohols, for example, C₁ to C₄ alcohols or C₂ to C alcohols. Specific examples include methanol, ethanol, propanol (e.g. iso-propanol) and butanol. In one example, the alcohol solvent may be ethanol.

Where the solvent is an ether solvent, any suitable ether solvent may be used. In some examples, the ether comprises a cyclic ether having a 3 to 8 membered ring, for example, a 5 or 6 membered ring. The cyclic ether may be a mono- or di-ether. The cyclic ether may have 2 to 6 ring carbons, for example, 3 to 4 ring carbons. Examples include tetrahydrofuran, dioxane and dioxalane. In some examples, cyclic ether solvents may be used. In one example, the ether solvent may be tetrahydrofuran. Cyclic ether solvents, for example, tetrahydrofuran may be employed as the solvent in the pre-treatment composition, for example, in seaming a polymer film to form a shrink sleeve. The same cyclic ether (e.g. tetrahydrofuran) solvent may be used a seaming solvent in a subsequent solvent-bonding step.

An example of a ketone solvent may be R′R″C═O, where R′ and R″ are each independently selected from an alkyl group, for example, a C₁ to C₈ alkyl group, for instance, a methyl, ethyl, propyl or butyl group. In some examples, the ketone comprises a cyclic ketone. Suitable cyclic ketones may have a 3 to 8 membered ring, for example, a 5 or 6 membered ring. The cyclic ketone may have up to 8 ring carbons, for example, 5 or 6 ring carbons. In one example, the ketone may be acetone.

Mixtures of solvents may be used. Organic solvent(s) may be employed in admixture with water.

### Method of Sealing

As mentioned above, the present disclosure also provides a method of sealing a first region of polymer film to a second region of polymer film. The method comprises applying a pre-treatment composition comprising a halogenated carboxylic acid, a surfactant, and a liquid solvent to a first region of polymer film; and sealing the pre-treated first region to a second region of polymer film. The first region of polymer film may be located on a different sheet of polymer film from the second region of polymer film. Accordingly, the seal formed by bonding the first region to the second region may bond two separate sheets of polymer film together.

Alternatively, the first region of polymer film may be on the same sheet of polymer film as the second region of polymer film. In one example, the first region of the polymer film is an edge region of a sheet of polymer film. The second region of the polymer film may be an opposing edge region of the same sheet of polymer film. By sealing the first edge region and second edge region, a sleeve, for example, a shrink sleeve may be formed of the polymer film.

In one example, the polymer film may be a shrink sleeve substrate comprising a sheet comprising the polymer film. To form the sleeve, an edge region on one face of the sheet may be sealed to an opposing edge region on the opposite face of the sheet. In one example, at least one face, for instance, an ink-receiving face of the sheet may be primed with a primer. The pre-treatment composition may be applied to an edge region of the primed face to inactivate the primer. Once pre-treated, the pre-treated region may be sealed to an opposing edge region on the opposite (e.g. un-primed) face of the sheet to form a seal. Thus sealed, the substrate provides a tubular sleeve that may be heat shrunk as a heat shrink label around a container.

The pre-treatment composition may be applied to the first region of polymer film using any suitable method. For example, the pre-treatment composition may be applied by coating, spray deposition or injection over desired area.

Where the pre-treatment composition is applied by coating, the coating may be performed by any roll coating, for example, gravure coating. Alternatively, the pre-treatment composition may be injected using an injection unit comprising a syringe or needle e.g. fitted with a felt wick. The composition can be supplied to the needle or felt continuously from the reservoir. In the case of the felt-fitted needle, the pre-treatment may be accomplished by mechanical pressure, allowing the composition to penetrate through the primer to plastic. Another piece of e.g. felt can be used to remove residues from the sealing/seaming area after pre-treatment. When used, the injection unit can be disposed at any suitable point within the printing system. For example, in the case of sealing, the injection unit may be positioned downstream of the printer so that the pre-treatment composition is applied on polymer film after it has been printed. In the case of seaming, the injection unit may be positioned up stream of the seaming unit. In some examples, the injection unit may be used as part of a separate off-line process.

In one example, the pre-treatment composition may be applied in a seaming machine prior to formation of a seal. In some examples, the pre-treatment composition may be applied after the polymer film has been primed with a primer. In some examples, the pre-treatment composition may be applied after the polymer film has been primed with a primer and printed with an electrophotographic ink composition. In some examples, the pre-treatment composition may be applied after the polymer film has been primed with a primer but before it is printed with an electrophotographic ink composition.

Once the first region is pre-treated, the second region of polymer film may be sealed to the first region. Any suitable sealing method may be used. For example, a seal may be formed by heat-sealing. In such a method, opposing regions of polymer film may be pressed together and heated. The heating may soften the polymer, causing at least part of the polymer to melt. The pressure may cause the softened polymer to bond together to form a seal.

Where a heat-sealing method is used, the polymer film may be heated to temperatures above the melting point of the polymer film. The precise temperature may vary depending on the specific nature of the polymer film. However, suitable temperatures range from 80 to 250 degrees C., for example, 110 to 200 degrees C.

Suitable pressures employed for sealing may range from 150 to 900N, for example, 200 to 600 N.

In some examples, the seal may be formed by solvent-bonding. In such a method, a sealing solvent may be applied to a region of the polymer film. The sealing solvent may be selected to be capable of softening the polymer, for example, by partially dissolving the polymer molecules in the solvent-treated region. The treated region may then be brought into contact with another region of polymer film and pressure applied to form a seal.

Any suitable sealing solvent may be employed. The precise nature of the solvent may depend on the nature of the film in question. The sealing solvent may comprise the same or different solvent(s) to the solvent(s) used as the liquid solvent in the pre-treatment composition.

In some examples, the sealing solvent comprises at least one solvent selected from an ether or a ketone. In some examples, the sealing solvent comprises at least one cyclic ether or cyclic ketone. In some examples, the sealing solvent comprises a cyclic ether having a 3 to 8 membered ring, for example, a 5 or 6 membered ring. The cyclic ether may be a mono- or di-ether. The cyclic ether may have 2 to 6 ring carbons, for example, 3 to 4 ring carbons. In some examples, the sealing solvent comprises a cyclic ketone having a 3 to 8 membered ring, for example, a 5 or 6 membered ring. The cyclic ketone may have up to 8 ring carbons, for example, 5 or 6 ring carbons. Suitable examples include tetrahydrofuran and dioxolane or mixtures thereof. In some examples, the sealing solvent comprises tetrahydrofuran and optionally, dioxolane and/or cyclohexanone.

In one example, a sealing solvent may be applied to the first region once the first region has been pre-treated with the pre-treatment composition. The first region may then be contacted with the second region and pressure applied form a seal.

In another example, a sealing solvent may be applied to the second region. The solvent-treated second region may be contacted with the pre-treated first region and pressure applied to form a seal.

### Polymer Film

The polymer film may be any suitable polymer film, for example, a polymer film for manufacturing product packaging or a label for product packaging. Suitable polymers include polypropylene terephthalate glycol PET(G), polyvinyl chloride (PVC), oriented polystyrene film (OPS), expanded polystyrene (EPS) and poly lactic acid (PLA). Other examples include polyethylene (PE) (e.g. linear low density polyethylene (LLDPE) and low density polyethylene (LDPE)); polypropylene (PP) (e.g. biaxially oriented polypropylene (BOPP)), polyethylene terephthalate, and polyamide (e.g. biaxially oriented polyamide).

The polymer film may form part of a laminated composite. The laminate composite may comprise other polymer layers or metal layers.

The film may have any suitable thickness. In some examples, the film may be less than 100 μm in thickness, for example less than 90 μm in thickness, less than 80 μm in thickness, less than 70 μm in thickness, less than 60 μm in thickness, less than 50 μm in thickness, less than 40 μm in thickness, less than 30 μm in thickness, less than 20 μm in thickness, less than 15 μm in thickness. In some examples, the film of material is about 12 μm in thickness.

In some examples, the film may be greater than 12 μm in thickness, for example greater than 15 μm in thickness, greater than 20 μm in thickness, greater than 30 μm in thickness, greater than 40 μm in thickness, greater than 50 μm in thickness, greater than 60 μm in thickness, greater than 70 μm in thickness, greater than 80 μm in thickness, greater than 90 μm in thickness. In some examples, the film of material is about 100 μm in thickness.

The film may be treated by corona treatment, for example, prior to application of any primer.

### Primer

As alluded to above, the polymer film may be primed prior to application of the pre-treatment composition. The purpose of the primer may be to improve adhesion of printed ink to the polymer film. The primer may be applied to the same face of the polymer film as the face onto which the pre-treatment composition is applied.

Any suitable primer may be used. Suitable primers include polymeric primers, for example, comprising a polymer and a solvent. In some examples, the primer comprises a polymer emulsion. Suitable solvents include aqueous solvents, for example, water. The concentration of polymer in the solvent may be 5 to 30 weight %, for example, 10 to 15 weight %.

In some examples, the primer may be selected from ethylene acrylic/methacrylic acid or acrylate/methacrylate copolymer emulsions, ethylene acrylic ionomers (saponified acrylic acid), polyamides, polyurethanes, polyamines, polyethylene imines, ethylene vinyl alcohol and ethylene vinyl acetate copolymer emulsions. The primer may also comprise a polymer comprising a polar group. Examples of polar groups include sulfonic, phosphonic, anhydride and silane groups.

In one example, a primer coating comprising a mixture of: a) about 60 to 95% by weight of a copolymer of ethylene and acrylic or methacrylic acid in an aqueous dispersion containing from about 10 to about 40% by weight total solids; and b) about 10 to 40% by weight of an adhesion enhancer comprising a hydrogenated rosin or rosin ester.

Examples of such primers are described in U.S. Pat. No. 8,198,353.

In one example, the primer comprises polyethylene imine. In one example, the primer comprises a 1 to 30 weight % (e.g. 5 to 20 weight %) polyethylene imine dissolved in water. In some examples, the primer is a primer sold under the trademark Michelman® DP050 and Michelman® DP050.

The primer may also include at least one of crosslinkers, antifoaming agents, levelling (wetting) agents, and antiblocking agents.

The primer may be applied as a layer in an amount of 0.01 to 5 g/m² of polymer film, for example, 0.02 to 3 g/m² of substrate. In one example, the primer is applied in an amount of 0.03 to 1.5 g/m² of substrate, for example, 0.04 to 1 g/m² of polymer film. In one example, the primer is applied in an amount of 0.05 to 0.8 g/m² of substrate, for example, 0.1 to 0.5 g/m² of polymer film.

The primer may be applied using any suitable method, including painting, dipping, spreading and gravure coating. In one example, the primer is applied by mechanical means and is not digitally printed.

In some examples, the primer is an analogue primer that is not suitable for electrophotographic printing. For example, the primer may be devoid of charge adjuvant and/or charge director. The primer may be a non-selective analogue primer, as it cannot be targeted onto selected areas of the substrate by digital printing.

### Electrophotographic Printing

The polymer film may be printed, for example, as a printed label. In some examples, the film may be primed prior to printing. The polymer film may be printed prior to sealing. In some examples, the seal is formed between unprinted regions of the polymer film.

Any suitable printing method may be employed. For example, the polymer film may be electrophotographically printed with a liquid electrophotographic ink composition. An electrophotographic printing process involves creating an image on a photoconductive surface or photo imaging plate (PIP). The image that is formed on the photoconductive surface is a latent electrostatic image having image and background areas with different potentials. When an electrophotographic ink composition containing charged toner particles is brought into contact with the selectively charged photoconductive surface, the charged toner particles adhere to the image areas of the latent image while the background areas remain clean. The image is then transferred to a print substrate (e.g. paper) directly, or by first being transferred to an intermediate transfer member (e.g. a blanket) and then to the print substrate.

The electrophotographic ink composition may comprise a colorant and a thermoplastic resin dispersed in a liquid carrier. The electrophotographic ink composition may also include a charge director and/or a charge adjuvant.

In one example, the electrophotographic ink composition is electrophotographically printed onto a primed polymer film. The primed polymer film may have an ink-receiving surface that is primed with a primer. The electrophotographic ink composition may be printed onto the ink-receiving surface. Thereafter, the pre-treatment composition may be applied to a first region of the polymer film. The first region may be devoid of printed image. The first region may be sealed to a second region of polymer film, for example, as described above.

### Thermoplastic Resin of an Electrophotographic Ink Composition

As described above, an electrophotographic ink composition may comprise a thermoplastic resin. The thermoplastic resin may be a polymer of an alkylene (e.g. ethylene) and at least one of methacrylic acid or acrylic acid. In some examples, the thermoplastic resin comprises a first polymer of an alkylene (e.g. ethylene) and methacrylic acid and a second polymer of alkylene (e.g. ethylene) and acrylic acid. The ratio of the first polymer to the second polymer may be 1:1 to 10:1, for example, 2:1 to 8:1. In one example, ratio of the first polymer to the second polymer may be 3:1 to 6:1, for instance, 4:1 to 5:1. In one example, the transparent electrophotographic ink composition comprises a thermoplastic resin comprising a first copolymer of ethylene and methacrylic acid and a second copolymer of ethylene and acrylic acid. The ratio of the first polymer to the second polymer may be 1:1 to 10:1, for example, 2:1 to 8:1. In one example, ratio of the first polymer to the second polymer may be 3:1 to 6:1, for instance, 4:1 to 5:1. In one example, the first copolymer is a copolymer of ethylene and methacrylic acid sold under the trademark Nucrel® 699 (DuPont). In one example, the second copolymer is a copolymer of ethylene and acrylic acid sold under the trademark AC-5120 (Honeywell).

In some examples, the thermoplastic resin may be a polymer selected from ethylene or propylene acrylic acid co-polymers; ethylene or propylene methacrylic acid co-polymers; ethylene vinyl acetate co-polymers; co-polymers of ethylene or propylene (e.g. 80 wt % to 99.9 wt %) and alkyl (e.g. C1 to C5) esters of methacrylic or acrylic acid (e.g. 0.1 wt % to 20 wt %); co-polymers of ethylene (e.g. 80 wt % to 99.9 wt %), acrylic or methacrylic acid (e.g. 0.1 wt % to 20.0 wt %) and alkyl (e.g. C1 to C5) esters of methacrylic or acrylic acid (e.g. 0.1 wt % to 20 wt %); co-polymers of ethylene or propylene (e.g. 70 wt % to 99.9 wt %) and maleic anhydride (e.g. 0.1 wt % to 30 wt %); polyethylene; polystyrene; isotactic polypropylene (crystalline); co-polymers of ethylene and ethyl acrylate; polyesters; polyvinyl toluene; polyamides; styrene/butadiene co-polymers; epoxy resins; acrylic resins (e.g. co-polymer of acrylic or methacrylic acid and at least one alkyl ester of acrylic or methacrylic acid wherein alkyl may have from 1 to about 20 carbon atoms, such as methyl methacrylate (e.g. 50% to 90%)/methacrylic acid (e.g. 0 wt % to 20 wt %)/ethylhexylacrylate (e.g. 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as SURLYN™ ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

The resin may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), and example of the second polymer is Nucrel 699 (from DuPont), and an example of the third polymer is AC-5120 or AC-5180 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin in the electrophotographic composition comprises a single type of polymer, the polymer (excluding any other components of the electrostatic composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

The resin may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g. Zn, Na, Li) such as SURLYN® ionomers. The resin may comprise (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt % to about 16 wt % of the co-polymer, in some examples 10 wt % to 16 wt % of the co-polymer, and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt % to about 30 wt % of the co-polymer, in some examples from 14 wt % to about 20 wt % of the co-polymer, in some examples from 16 wt % to about 20 wt % of the co-polymer in some examples from 17 wt % to 19 wt % of the co-polymer.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, i5 respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer.

The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer. with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the Bynel® class of monomer, including Bynel 2022 and Bynel 2002, which are available from DuPont®.

The polymer having ester side groups may constitute 1% or more by weight of the total amount of the resin polymers, e.g. thermoplastic resin polymers, in the liquid electrophotographic composition, e.g. the total amount of the polymer or polymers having acidic side groups and polymer having ester side groups. The polymer having ester side groups may constitute 5% or more by weight of the total amount of the resin polymers, e.g. thermoplastic resin polymers, in some examples 8% or more by weight of the total amount of the resin polymers, e.g. thermoplastic resin polymers, in some examples 10% or more by weight of the total amount of the resin polymers, e.g. thermoplastic resin polymers, in some examples 15% or more by weight of the total amount of the resin polymers, e.g. thermoplastic resin polymers, in some examples 20% or more by weight of the total amount of the resin polymers, e.g. thermoplastic resin polymers, in some examples 25% or more by weight of the total amount of the resin polymers, e.g. thermoplastic resin polymers, in some examples 30% or more by weight of the total amount of the resin polymers, e.g. thermoplastic resin polymers, in some examples 35% or more by weight of the total amount of the resin polymers, e.g. thermoplastic resin polymers, in the liquid electrophotographic composition. The polymer having ester side groups may constitute from 5% to 50% by weight of the total amount of the resin polymers, e.g. thermoplastic resin polymers, in the liquid electrophotographic composition, in some examples 10% to 40% by weight of the total amount of the resin polymers, e.g. thermoplastic resin polymers, in the liquid electrophotographic composition, in some examples 5% to 30% by weight of the total amount of the resin polymers, e.g. thermoplastic resin polymers, in the liquid electrophotographic composition, in some examples 5% to 15% by weight of the total amount of the resin polymers, e.g. thermoplastic resin polymers, in the liquid electrophotographic composition in some examples 15% to 30% by weight of the total amount of the resin polymers, e.g. thermoplastic resin polymers, in the liquid electrophotographic composition.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, Bynell 2020 and Bynell 2022, (sold by E. I. du PONT)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)).

The resin can constitute about 5 to 90%, in some examples about 50 to 80%, by weight of the solids of the liquid electrophotographic composition. The resin can constitute about 60 to 95%, in some examples about 70 to 95%, by weight of the solids of the liquid electrophotographic composition.

### Charge Adjuvant of an Electrophotographic Ink Composition

The electrophotographic composition can include a charge adjuvant. A charge adjuvant may be present with a charge director, and may be different to the charge director, and act to increase and/or stabilise the charge on particles, e.g. resin-containing particles, of an electrostatic composition. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di and/or tristearate and/or aluminium di and/or tripalmitate.

The charge adjuvant can constitute about 0.1 to 5% by weight of the solids of the liquid electrophotographic composition. The charge adjuvant can constitute about 0.5 to 4% by weight of the solids of the liquid electrophotographic composition. The charge adjuvant can constitute about 1 to 3% by weight of the solids of the liquid electrophotographic composition.

### Charge Director of an Electrophotographic Ink Composition

A charge director may be added to the electrophotographic composition. In some examples, the charge director comprises nanoparticles of a simple salt and a salt of the general formula MAₙ, wherein M is a barium, n is 2, and A is an ion of the general formula [R₁—O—C(O)CH₂CH(SO₃⁻)C(O)—O—R₂], where each of R₁ and R₂ is an alkyl group.

The sulfosuccinate salt of the general formula MA is an example of a micelle forming sat. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 10 nm or less, in some examples 2 nm or more (e.g. 4-6 nm).

The simple salt may comprise a cation selected from Mg, Ca, Ba, NH₄, tert-butyl ammonium, Li⁺, and Al⁺³, or from any sub-group thereof. In one example, the simple salt is an inorganic salt, for instance, a barium salt. The simple salt may comprise an anion selected from SO₄²−, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. In some examples, the simple salt comprises a hydrogen phosphate anion.

The simple salt may be selected from CaCO₃, Ba₂TiO₃, Al₂(SO₄)₃, Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO, LiTFA, Al₂(S₄)₃, LiClO₄ and LiBF₄ or any sub-group thereof. In one example, the simple salt may be BaHPO₄.

In the formula [R₁—O—C(O)CH₂CH(SO₃⁻)C(O)—O—R₂], in some examples, each of R₁ and R₂ is an aliphatic alkyl group. In some examples, each of R₁ and R₂ independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇.

In an electrophotographic composition, the charge director can constitute about 0.001% to 20%, in some examples 0.01 to 20% by weight, in some examples 0.01 to 10% by weight, in some examples 0.01 to 1% by weight of the solids of the electrostatic composition. The charge director can constitute about 0.001 to 0.15% by weight of the solids of the liquid electrophotographic composition, in some examples 0.001 to 0.15%, in some examples 0.001 to 0.02% by weight of the solids of the liquid electrophotographic composition. In some examples, the charge director imparts a negative charge on the electrostatic composition. The particle conductivity may range from 50 to 500 pmho/cm, in some examples from 200-350 pmho/cm.

### Carrier Liquid for an Electrophotographic Ink Composition

The carrier liquid for the liquid electrophotographic composition can act as a dispersing medium for the other components in the electrostatic composition. For example, the carrier liquid can comprise or be a hydrocarbon, silicone oil, vegetable oil, etc. The carrier liquid can include, but is not limited to, an insulating, non-polar, non-aqueous liquid that can be used as a medium for toner particles. The carrier liquid can include compounds that have a resistivity in excess of about 10⁹ ohm-cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, isoparaffinic compounds, paraffinic compounds, dearomatized hydrocarbon compounds, and the like. In some examples, the carrier liquid is an isoparaffinic liquid. In particular, the carrier liquids can include, but are not limited to liquids sold under the trademarks, Isopar-G™, Isopar-H™, Isopar-L™, Isopar-M™ Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0Solvent™, #0 Solvent HM, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco460™ (each sold by AMERICAN MINERAL SPIRITS CORP.); and Electron, Positron, New II, Purogen HF (100% synthetic terpenes) (sold by ECOLINK™).

Before printing, the carrier liquid can constitute about 20% to 99.5% by weight of the electrostatic composition, in some examples 50% to 99.5% by weight of the electrostatic composition. Before printing, the carrier liquid may constitute about 40 to 90% by weight of the electrostatic composition. Before printing, the carrier liquid may constitute about 60% to 80% by weight of the electrostatic composition. Before printing, the carrier liquid may constitute about 90% to 99.5% by weight of the electrostatic composition, in some examples 95% to 99% by weight of the electrostatic composition.

The composition when printed on the print substrate, may be substantially free from carrier liquid. In an electrostatic printing process and/or afterwards, the carrier liquid may be removed, e.g. by an electrophoresis processes during printing and/or evaporation, such that substantially just solids are transferred to the print substrate. Substantially free from carrier liquid may indicate that the ink printed on the print substrate contains less than 5 wt % carrier liquid, in some examples, less than 2 wt % carrier liquid, in some examples less than 1 wt % carrier liquid, in some examples less than 0.5 wt % carrier liquid. In some examples, the ink printed on the print substrate is free from carrier liquid.

### Colorants of an Electrophotographic Ink Composition

Colorants in the electrophotographic ink composition may be selected from a pigment, dye and a combination thereof. The colorant may be selected from a cyan colorant, a yellow colorant, a magenta colorant and a black colorant. The colorant may be selected from a phthalocyanine colorant, an indigold colorant, an indanthrone colorant, a monoazo colorant, a diazo colorant, inorganic salts and complexes, dioxazine colorant, perylene colorant, anthraquinone colorants, and any combination thereof.

Where present, the colorant may be present in an amount of 0.1 to 10 weight %, for instance, 2 to 5 weight % of the total weight of solids of the composition.

### EXAMPLES

### Example 1

A lab scale seaming test was carried out using the following steps:

### Step 1: “Cleaning” of Primer

5×10 cm strips of shrink sleeves substrate PETG (40 micron) coated in one side with a polyethylene imine primer (Michelman® Digiprime 050) were prepared. The primed side of one strip was treated with Mixture 1 using felt wick. The mixture 1 contained 2% of TFA (trifluoro acetic acid) and up to 0.1% of polyethylene glycol mono(3-(tetramethyl-1-(trimethylsiloxy)disiloxanyl)propyl)ether (Silwet® L77, produced by Momentive) in a mixture of 90% THF and water. Mixture 1 was applied using felt wick (0.5/1 sm of contact area). The treated area was wiped by cotton cloth immediately after applying of the Mixture 1. Indictor (Michem Indicator 102) was applied to observe the absence of the amine form of primer film at the cleaned area.

### Step 2: Seaming

The cleaned area of primed substrate was treated with THF using the same felt wick as it was described in step 1. The non-primed strip was attached immediately and the pressure (1 kg) was applied for 2 sec. The seamed strips were allowed to bond for 5 min.

### Step 3. Examination of the Seaming Strength

Two seamed strips were pulled in opposite directions manually to examine the seam strength. The results are shown in Table 1 below.

### Example 2

The same procedure was applied as it described for Example 1, using mixture 2. The mixture 2 contained 2% TFA in 90% THF/water mixture and 0.02% of Sodium Dodecyl Sulfate. The results are shown in Table 1 below.

### Example 3: Comparative

THF was applied directly to a primed strip at the manner described above in Step 2, and a non-primed strip was attached immediately. Pressure (1 kg) was applied for 2 sec and the strips allowed to stand for 5 min.

Examination of the seaming strength obviously shows very weak bonding: the strips are deattached easily. The results are shown in Table 1 below.

### Example 4: Comparative

THF was applied to a non-primed strip at the manner described above in Step 2 and a non-primed strip was attached immediately. The pressure (1 kg) was applied for 2 sec and the strips allowed to stand for 5 min.

Examination of the seaming strength obviously shows very strong bonding: the strips teared while detachment.

The results of Examples 1 to 4 are summarized in Table 1 below.

TABLE 1

| | | Composition of | | |
|---|---|---|---|---|
| | | Pre-cleaning | | A seaming |
| | | solution | | strength |
| Exam- | | (pre-treatment | Seaming | (manually |
| ple | substrate | composition) | solvent | test) |
| 1 | primed | Mixture of | THF | tear |
| | | Example 1 | | |
| 2 | primed | Mixture of | | tear |
| | | Example 2 | | |
| 3 | primed | no | | no seam |
| 4 | Non-primed | no | | tear |
| | comparative | | | |

The results show that the seams formed using the pre-treatment composition as described in Examples 1 and 2 are comparable to the seam formed between unprimed films. Untreated primer, however, disrupts the strength of the seal (see Example 3).

### Example 5

A lab scale seaming test was carried out using the following steps:

### Step 1: “Cleaning” of Primer

5×10 cm strips of PE containing substrate (AI/PE sheet (Global A17/90PE, 100p) coated on one side with a polyethylene imine primer (Michelman® Digiprime 050) were prepared. The mixtures contained 5% of TFA (trifluoro acetic asid), 0.05% of Sodium dodecyl sulphate (Sigma) in a mixture of ethanol in water. The Mixtures 1-5 were applied using felt wicks (0.5/1 cm of contact area). The treated areas was wiped by cotton cloth immediately after applying the mixtures. Indicator (Michem® Indicator 102) was applied to observe the absence of the amine form of primer film at the cleaned area.

### Step 2: Sealing

“Cleaned” areas of primed substrate was combined with the non-primed PE substrate. Sealing was performed in semi-automatic Sealer. (Conditions: top jaw 200° C., Bottom jaw: 200° C., Dwell time: 0.1 sec, pressure 450N.)

The flat jaws was used and seal area was 1 cm×15 cm. Lamination bond strength was measured according to ASTM F0904-98R08. The results of the sealing strength are represented in Table 2 below.

As a comparison, non-primed areas of the substrate were sealed as described above (Ref. 1 in Table 2 below). As a further comparison, a primed substrate was sealed to a non-primed substrate using the procedure described above.

The results in Table 2 show that the seams formed using the pre-treatment composition as described in Mixtures 1-5 are compare reasonably well to the seam formed between unprimed films (Ref. 1). Untreated primer, however, disrupts the strength of the seal (see Ref. 2)

TABLE 2

| | Part by volume | | | | |
|---|---|---|---|---|---|
| | EtOH. | Water, | TFA, | SDS; | SBS |
| Mixture | ml | ml | ml | % | (N/inch) |
| 1 | 95 | | 5 | 0.05 | 23 |
| 2 | 98 | | 2 | 0.05 | 20 |
| 3 | | 95 | 5 | 0.05 | 11 |
| 4 | 50 | 50 | 5 | 0.05 | 23 |
| 5 | 90 | 10 | 5 | 0.05 | 25 |
| Ref 1(non | | | | | 23 |
| primed) | | | | | |
| Ref 2 | | | | | appr. |
| (primed) | | | | | 1-2 |

While the compositions, methods and related aspects have been described with reference to certain examples, those skilled in the art will appreciate that various modifications, changes, omissions, and substitutions can be made without departing from the spirit of the disclosure. It is intended, therefore, that the invention be limited by the scope of the following claims. The features of any dependent claim may be combined with the features of any of the other dependent claims or any and/or any of the independent claims.

1. A pre-treatment composition for sealing polymeric film, said composition comprising:
0.5 to 10 weight % of a halogenated carboxylic acid,
a surfactant, and
a liquid solvent.

2. A composition as claimed in claim 1, which comprises 0.7 to 6 weight % halogenated carboxylic acid.

3. A composition as claimed in claim 1, wherein the halogenated carboxylic acid is a halogenated acetic acid.

4. A composition as claimed in claim 3, wherein the halogenated acetic acid is selected from trichloroacetic acid, dichloroacetic acid, chloroacetic acid, trifluoroacetic acid and difluoroacetic acid.

5. A composition as claimed in claim 1, wherein the surfactant comprises a trisiloxane surfactant.

6. A composition as claimed in claim 1, wherein the liquid solvent comprises at least one solvent selected from water, an alcohol, a ketone and an ether.

7. A composition as claimed in claim 6, wherein the liquid solvent comprises at least one solvent selected from water, ethanol and tetrahydrofuran.

8. A method of sealing a first region of polymer film to a second region of polymer film, said method comprising
applying a pre-treatment composition comprising 0.5 to 10 weight % of a halogenated carboxylic acid, a surfactant, and a liquid solvent to a first region of polymer film;
sealing the pre-treated first region to a second region of polymer film.

9. A method as claimed in claim 8, wherein, prior to application of the pre-treatment composition, a primer is applied to at least the first region of polymer film.

10. A method as claimed in claim 9, wherein the second region of polymer film is not coated with primer.

11. A method as claimed in claim 8 wherein the first region of polymer film is sealed to the second region of polymer film to form a sleeve.

12. A method as claimed in claim 11, wherein the method further comprises applying the sleeve to a container and heating the sleeve to shrink the sleeve to the shape of the container.

13. A method as claimed in claim 9, wherein the primer comprises polyethylene imine.

14. A method as claimed in claim 8, wherein sealing is carried out by contacting the pre-treated first region with a sealing solvent and then contacting the second region of polymer film to the first region.

15. A method as claimed in claim 8, which comprises:
providing a polymer film having an ink-receiving surface that is primed with a primer;
electrophotographically printing an electrophotographic ink composition onto the ink-receiving surface;
applying a pre-treatment composition comprising 0.5 to 10 weight % of a halogenated carboxylic acid, a surfactant, and a liquid solvent to a first region of polymer film; and
sealing the pre-treated first region to a second region of polymer film.
